(19) United States
(12) Patent Application Publication
(10) Pub. No.: US 2011/0202246 A1
(43) Pub. Date: Aug. 18, 2011

(54) VEHICLE PARKING BRAKE CONTROL SYSTEM

(76) Inventors: RYAN LINDSAY, MOLINE, IL (US); MICHAEL THIEME, SCHIFFERSTADT (DE); PETER MÜNCH, SCHIFFERSTADT (DE)

(21) Appl. No.: 13/017,156

(22) Filed: Jan. 31, 2011

(30) Foreign Application Priority Data
Feb. 17, 2010 (DE) 102010002020.6

(51) Int. Cl. B60T 8/171

(52) U.S. Cl. 701/70

(57) ABSTRACT

A system for controlling a parking brake for a motor vehicle includes a first operator control arrangement and a control unit. The control unit puts the parking brake into a disengaged position by actuating a first electrical actuator when it recognizes a release request on the first operator control arrangement. In order to release the parking brake at least in the event of a fault in the first operator control arrangement and/or in the first electrical actuator, provision is also made for the control unit to put the parking brake into the disengaged position by actuating a second electrical actuator, which is independent of the first electrical actuator, redundantly when it recognizes an emergency release request on a second operator control arrangement.

### FIELD OF THE INVENTION

The present disclosure relates to a system for controlling a parking brake for a motor vehicle.

### BACKGROUND OF THE INVENTION

A system for controlling a parking brake in a motor vehicle is described by DE 10052261 A1, for example. This known system has an actuating drive in the shape of a hydraulic piston which can be operated by an actuator and which can be used to put a locking device which the parking brake comprises into a disengaged position contrary to a restoring force and in this way to release it. The actuator is preferably in the form of an electromagnetic hydraulic valve which can be operated by a control unit. The control unit derives the request to release the parking brake from a sensed position of an operator control lever which can be operated by the driver. In addition, a mechanical emergency operation device is provided which allows the locking device to be put into the disengaged position, and locked therein, by means of a Bowden cable which can be mounted on a clutch pedal of the motor vehicle.

The additional mechanical components which are required for the emergency operation device mean that the known system is of comparatively complex design.

It is therefore an object of the present invention to develop a system of the type cited at the outset such that it renders the presence of an additional mechanical emergency operation device superfluous.

### SUMMARY

According to an aspect of the present disclosure, the system for controlling a parking brake for a motor vehicle comprises a first operator control arrangement and at least one control unit, wherein the at least one control unit puts the parking brake into a disengaged position by actuating a first electrical actuator when it recognizes a release request on the first operator control arrangement. In order to be able to release the parking brake at least in the event of a fault in the first operator control arrangement and/or in the first electrical actuator, provision is also made for the at least one control unit to put the parking brake into the disengaged position by actuating a second electrical actuator, which is independent of the first electrical actuator, redundantly when it recognizes an emergency release request on a second operator control arrangement. The two electrical actuator may in this context be a physical component of one and the same electrically operatable parking brake. An additional mechanical emergency operation device can be dispensed with in this case, since the likelihood of the at least one control unit or the second operator control arrangement and/or the second electrical actuator having a fault as well is negligibly low.

The parking brake preferably corresponds to the embodiment presented in EP 1 795 410 B1. Accordingly, it comprises a locking arm which is swivel-mounted within a carrier housing which can be mounted on a vehicle transmission. The locking arm has a locking pawl which can be made to engage in teeth on an output gearwheel of the vehicle transmission, under the influence of a spring-generated initial tension force, such that rotation of the output gearwheel and hence undesirable movement of the motor vehicle are prevented. To release the parking brake, an electromagnetic operating element is provided which comprises a magnetic core which is mounted on the carrier housing and which contains an armature interacting with a knee joint arrangement for the purpose of operating the locking arm. A first coil wound around the magnetic core is used to produce a magnetic field. When the magnetic field is applied, the armature acts on the knee joint arrangement such that the locking arm is put into a disengaged position, which releases the teeth of the output gearwheel, counter to the initial tension force. In addition, a second coil is provided for redundantly releasing the parking brake. This coil is likewise wound around the magnetic core of the electromagnetic operating element. In other words, the electromagnetic operating element has a first electrical actuator, comprising the first coil, and a second electrical actuator, comprising the second coil, for the purpose of redundantly releasing the parking brake. When the magnetic field is switched off, the locking arm automatically returns from the disengaged position to the engaged position under the influence of the initial tension force. The parking brake is then locked again.

In order to allow emergency release of the parking brake even in the event of failure of the vehicle's own power supply, for example as a result of an inadequate charge state of the vehicle battery, it is advantageous if the motor vehicle is provided with an externally accessible auxiliary power connection which can be used to supply power to the at least one control unit together with the second operator control arrangement and/or the second electrical actuator.

The first and/or second operator control arrangement particularly comprises a drive-position selector lever which can be moved into at least one neutral, park or drive position and which is connected to a vehicle transmission, wherein at least one position sensor indicating the instantaneous position of the drive-position selector lever is provided. By way of example, the vehicle transmission may be in the form of an “Infinitely Variable Transmission” (IVT), in which a hydrostatically or electrically driven transmission path interacts with the multiplicity of mechanically switchable planetary gears such that the gear ratio of the vehicle transmission can be adjusted in an infinitely variable manner.

In such a vehicle transmission, the drive-position selector lever is moved from the park position into the neutral position and from there into the relevant drive position in order to start a journey, i.e. in order to make headway or reverse. Accordingly, it is possible for the at least one control unit to infer the presence of a release request when a position signal provided by the position sensor reveals that the drive-position selector lever is being moved from the park position into the neutral position by the driver.

In addition to the neutral position, the drive-position selector lever may have a “Power Zero” position which allows the motor vehicle to taxi to a standstill, wherein the parking brake is automatically moved into the engaged position from a disengaged position after the standstill has been reached and after a prescribed safety time has subsequently elapsed.

The first operator control arrangement may have at least one first position sensor, indicating the park position of the drive-position selector lever, and a second position sensor, indicating the neutral position of the drive-position selector lever, wherein the at least one control unit compares the position signals provided by the two position sensors with one another in order to verify the instantaneous position of the drive-position selector lever. The position sensors are in the form of Hall sensors, in particular. A component entrained with the drive-position selector lever carries one or more permanent magnets which are arranged such that the Hall sensors are subjected to a magnetic field strength which is explicitly related to the instantaneous position of the drive-position selector lever. Each of the Hall sensors produces a position signal in the shape of a voltage signal which is dependent on the respective magnetic field strength, wherein evaluation of the respective absolute value or profile of the voltage signals and comparison of the temporal relationship between said voltage signals allow the instantaneous position of the drive-position selector lever to be reliably ascertained.

Preferably, the at least one control unit infers the presence of an emergency release request when the second operator control arrangement is operated in compliance with a prescribed operator control sequence within the context of an “release code” which is to be input. This allows unintentional or inadvertent emergency release of the parking brake by the driver to be reliably prevented.

In particular, the second operator control arrangement may comprise an operator control pedal which interacts with a transmission clutch and/or a vehicle brake system, wherein at least one operation sensor sensing the instantaneous operation state of the operator control pedal is provided. To be more precise, the operator control pedal can be used to open and close a transmission clutch or to actuate wheel brake devices interacting with vehicle wheels. By way of example, the operation sensor is a variable resistor in the form of a potentiometer which can be used to sense deflection of the operator control pedal by the driver and to convert it into an operation signal in the shape of an appropriate actuating signal.

Furthermore, it is possible for the second operator control arrangement to have a third position sensor indicating at least the park and/or neutral position of the drive-position selector lever, wherein the at least one control unit infers the presence of an emergency release request when evaluation of a position signal, provided by the third position sensor, in conjunction with an operation signal, provided by the operation sensor, reveals that the drive-position selector lever is being moved from the park position into the neutral position at the same time as the operator control pedal is being operated by the driver. In other words, the third position sensor redundantly senses the instantaneous position of the drive-position selector lever. In the simplest case, the third position sensor is a microswitch which is operated when the drive-position selector lever is moved out of the park position and which then produces a position signal in the shape of an appropriate switching signal.

In order to preclude unintentional emergency release, it is conceivable for the at least one control unit to put the parking brake into the disengaged position exclusively when it is in a manually selectable emergency release mode. The emergency release mode can be selected using a bypass switch accommodated in a vehicle fuse box, for example. In particular, the bypass switch has a contact base and a contact bridge which can be manually plugged onto the contact base in various positions, wherein the emergency release mode is selected by plugging on the contact bridge in a position provided specifically for that purpose.

Preferably, the position signals from the first and second position sensors are transmitted redundantly via a bus connection, particularly via a CAN data bus which is present in the motor vehicle, to the at least one control unit. To be more precise, the position signals produced by the two position sensors are transmitted to at least one control unit firstly directly and secondly after prior conversion by an interposed CAN driver. By comparing the position signals transmitted in different ways, it is possible to recognize erroneous information transmission between the two position sensors and the at least one control unit.

To provide the greatest possible fail-safety for the system according to the invention, the first and second operator control arrangements have mutually independent control units associated with them for the purpose of redundantly actuating the first and second electrical actuator. In this respect, two mutually independent control paths are provided for operating the parking brake, wherein the first electrical actuator is actuated by the first control unit and the second electrical actuator is actuated by the second control unit.

In this context, the two control units can communicate with one another via a bus connection, particularly via a CAN data bus which is present in the motor vehicle. This allows reciprocal operational monitoring of the control units. If erroneous operation of one of the two control units is recognized, an appropriate error message can be output to the driver, for example by means of a display unit located in the driver's cab of the motor vehicle.

In addition, it is possible for the operator control arrangements, the control units and/or the electrical actuator to be powered from at least two mutually independent power supply paths. For this purpose, each of the power supply paths has a dedicated voltage stabilization circuit associated with it, the voltage stabilization circuits for their part being supplied with electrical power from the vehicle battery.

To prevent undesirable wear of the parking brake, it is additionally conceivable for at least one wheel speed sensor for sensing the instantaneous motion state of the motor vehicle to be provided, wherein the at least one control unit puts the parking brake into the engaged position from the disengaged position exclusively when a speed signal provided by the at least one wheel speed sensor reveals that the motor vehicle is stationary.

Preferably, a plurality of such wheel speed sensors are provided, wherein the at least one control unit compares the speed signals provided by the wheel speed sensors with one another for the purpose of reciprocal verification of said speed signals. In this case, a reliable statement about the instantaneous motion state of the motor vehicle, particularly about it being at a standstill, can be made even in the event of erroneous operation of one of the wheel speed sensors.

### BRIEF DESCRIPTION OF THE DRAWINGS

FIG. 1 is a schematic diagram of a parking brake control system for a motor vehicle;

FIG. 2 is a schematic diagram of an embodiment of a parking brake for a motor vehicle;

FIG. 3 is a flowchart which shows a method for the release of the parking brake; and

FIG. 4 is a flowchart which shows a method for the emergency release of the parking brake.

### DETAILED DESCRIPTION OF THE DRAWINGS

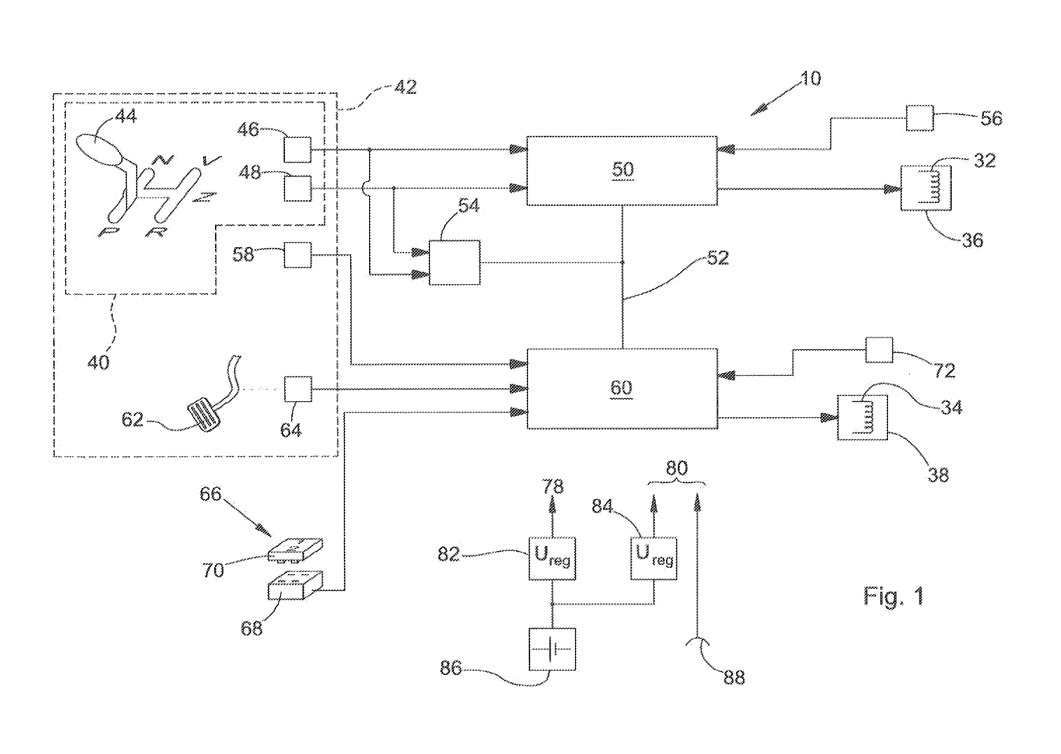

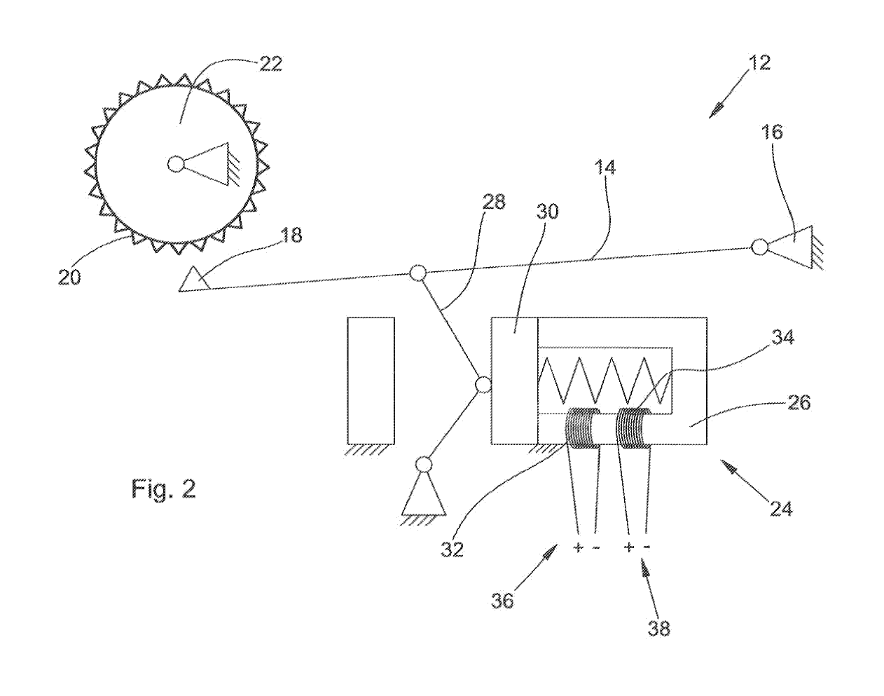

Referring to FIG. 1, the system 10 controls a parking brake 12 for a motor vehicle, the parking brake being shown in FIG. 2. The motor vehicle may be an agricultural or industrial commercial vehicle, for example a tractor, a harvester, a forage harvester, a self-propelled spraying machine or a construction machine.

The parking brake 12 can be actuated by the system 10 and corresponds to the embodiment presented in EP 1 795 410 B1. Accordingly, it includes a locking arm 14 which is swivel-mounted within a carrier housing 16 which can be mounted on a vehicle transmission. The locking arm 14 has a locking pawl 18 which can be made to engage teeth 20 on an output gearwheel 22 of the vehicle transmission, under the influence of a spring-generated initial tension force, to prevent rotation of the output gearwheel 22 and hence undesirable movement of the motor vehicle. To release the parking brake 12, an electromagnetic operating element 24 is provided which includes a magnetic core 26 which is mounted on the carrier housing 16 and which contains an armature 30 interacting with a knee joint arrangement 28 for the purpose of operating the locking arm 14. A first coil 32 wound around the magnetic core 26 is used to produce a magnetic field. When the magnetic field is applied, the armature 30 acts on the knee joint arrangement 28 such that the locking arm 14 is put into a disengaged position, which releases the teeth 20 of the output gearwheel 22, counter to the initial tension force. In addition, a second coil 34 is provided for redundantly releasing the parking brake 12. This coil 34 is likewise wound around the magnetic core 26 of the electromagnetic operating element 24. In other words, the electromagnetic operating element 24 has a first electrical actuator 36, comprising the first coil 32, and a second electrical actuator 38, comprising the second coil 34, for the purpose of redundantly releasing the parking brake 12. When the magnetic field is switched off, the locking arm 14 automatically returns from the disengaged position to the engaged position under the influence of the initial tension force. The parking brake 12 is then locked again. The system includes a drive-position selector lever 44 and a control pedal 62.

A first operator control arrangement 40 is defined as including only the selector lever 44. A second operator control arrangement 42 is defined as including both the selector lever 44 and the control pedal 62.

The selector lever 44 can be moved into at least one neutral, park or drive position and is connected to the vehicle transmission (not shown). In the present case, the vehicle transmission is in the form of an “Infinitely Variable Transmission” (IVT), in which a hydrostatically or electrically driven transmission path interacts with a multiplicity of mechanically switchable planetary gears such that the gear ratio of the vehicle transmission can be adjusted in an infinitely variable manner.

The first operator control arrangement 40 has a first position sensor 46, indicating the park position of the drive-position selector lever 44, and a second position sensor 48, indicating the neutral position of the drive-position selector lever 44. The position sensors 46 and 48 may be Hall sensors. A component (not shown) entrained with the drive-position selector lever 44 carries one or more permanent magnets which are arranged such that the Hall sensors are subjected to a magnetic field strength which is explicitly related to the instantaneous position of the drive-position selector lever 44. Each of the Hall sensors produces a position information signal as a voltage signal which is dependent on the respective magnetic field strength. The voltage signals provided by the two position sensors 46 and 48 are then supplied to a first control unit 50 and compared with one another in order to ascertain and subsequently verify the instantaneous position of the drive-position selector lever 44. To this end, besides the evaluation of the respective absolute value or time profile of the voltage signals, the temporal relationship of said voltage signals with one another is also compared.

The position signals from the first and second position sensors 46 and 48 are transmitted to the first control unit 50 redundantly via a bus 52. The bus 52 may be a CAN data bus which is present in the motor vehicle. To be more precise, the position signals produced by the two position sensors 46 and 48 are transmitted to the first control unit 50 firstly directly and secondly after prior conversion by an interposed CAN driver 54, so that by comparing the position signals transmitted in different ways it is possible to recognize erroneous information transmission between the two position sensors 46 and 48 of the first control unit 50.

A first wheel speed sensor 56 senses the speed of the motor vehicle and transmits to the first control unit 50 a speed signal for the wheel speed on a first wheel axle of the motor vehicle.

Furthermore, the second operator control arrangement 42 has a third position sensor 58 which indicates the park and/or neutral position of the drive-position selector lever 44 and which is used to redundantly sense the instantaneous position of the drive-position selector lever 44. The third position sensor 58 may be a microswitch which is operated when the drive-position selector lever 44 is moved out of the park position and which then produces a position signal in the shape of an appropriate switching signal which is supplied to a second control unit 60 for the purpose of evaluation.

The operator control pedal 62 interacts with a transmission clutch and/or a vehicle brake system, and a sensor 64 senses the position of the operator control pedal 62. The sensor 64 may be a variable resistor such as a potentiometer which senses deflection of the operator control pedal 62 by a driver and generates an appropriate actuating signal which is supplied to the second control unit 60 for the purpose of evaluation.

In addition, a bypass switch 66 is included in a vehicle fuse box. The bypass switch 66, which is connected to the second control unit 60, has a contact base 68 and a contact bridge 70 which can be manually plugged onto the contact base 68 in various positions.

A second wheel speed sensor 72 redundantly senses the instantaneous motion state of the motor vehicle. To this end, the second wheel speed sensor 72 transmits to the second control unit 60 a speed signal for the wheel speed on a second wheel axle of the motor vehicle.

By way of example, the first and second operator control arrangements 40 and 42 have mutually independent control units 50 and 60 associated with them for the purpose of redundantly actuating the first and second electrical actuator 36 and 38. In this respect, two mutually independent control paths are provided for the purpose of operating the parking brake 12, wherein the first electrical actuator 36 is actuated by the first control unit 50 and the second electrical actuator 38 is actuated by the second control unit 60.

In this context, the two control units 50 and 60 communicate with one another via the bus 52 for the purpose of reciprocal operational monitoring. If erroneous operation of one of the two control units 50 and 60 is recognized, an appropriate error message is output to the driver, for example using a display unit located in the driver's cab of the motor vehicle.

The operator control arrangements 40 and 42, the control units 50 and 60 and/or the electrical actuator 36 and 38 are powered from mutually independent power supply paths 78 and 80. For this purpose, each of the power supply paths 78 and 80 has a dedicated voltage stabilization circuit 82 and 84 associated with it, the voltage stabilization circuits 82 and 84 for their part being supplied with electrical power from the vehicle battery 86.

In addition, an auxiliary power connection 88 which is externally accessible on the motor vehicle is provided which can be used to supply power to the second control unit 60 together with the second operator control arrangement 42 or the second electrical actuator 38 in the event of an inadequate charge state of the vehicle battery 86.

As a departure from, the previously illustrated exemplary embodiment of the system 10, it is also conceivable to replace the first and second control units 50 and 60 merely with a single control unit, and to replace the first and second position sensors 46 and 48 merely with a single position sensor indicating the instantaneous position of the drive-position selector lever 44. To provide the greatest possible fail-safety for the system 10 according to the invention, however, operation of the parking brake 12 using two mutually independent control paths is preferred.

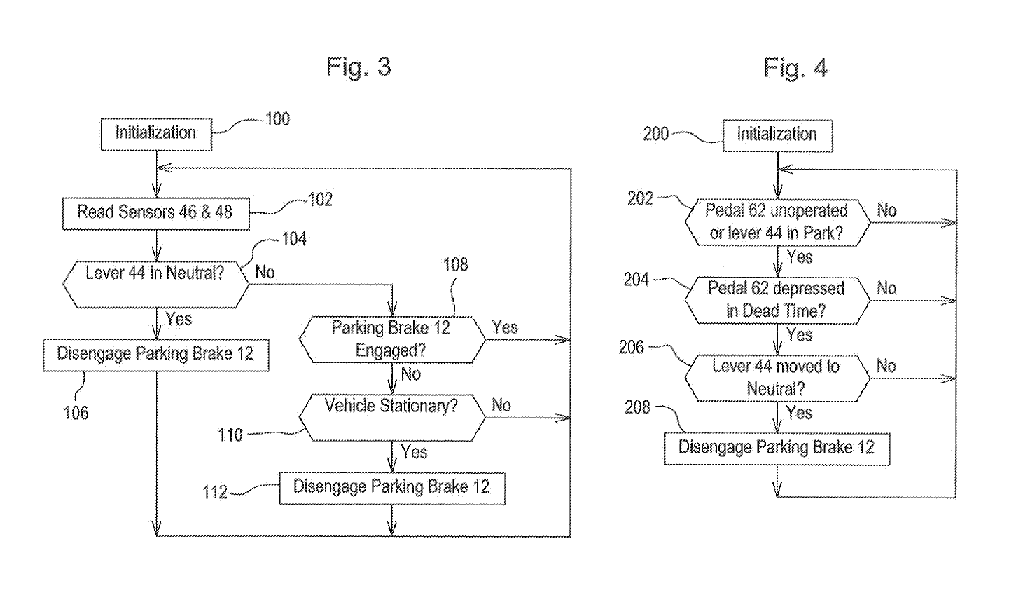

The control unit 50 periodically executes an algorithm or method represented by the flow chart of FIG. 3. The method begins at an initialization step 100. Then, in step 102 the control unit 50 ascertains the instantaneous position of the drive-position selector lever 44 by reading the position signals from position sensors 46 and 48.

As previously mentioned, the vehicle transmission is an IVT, which can be adjusted in an infinitely variable manner. In the case of such a vehicle transmission, the drive-position selector lever 44 is moved from the park position into the neutral position and from there into a drive position in order to start the vehicle moving in forward or reverse.

If, in step 104, the position signals indicate that the drive-position selector lever 44 is moved out of the park position and into the neutral position within a prescribed dead time, the presence of a release request is inferred and step 106 puts the parking brake 12 into the disengaged position by an appropriate actuation of the first electrical actuator 36.

Otherwise, step 104 establishes that the dead time has been exceeded or the drive-position selector lever 44 is not being moved out of the park position, and step 108 checks whether the parking brake 12 is in the engaged position. If this is the case, the method returns to the step 102. Otherwise, step 110 ascertains the motion state of the vehicle by evaluating the speed signal from wheel speed sensor 56 and the speed signal provided via the bus 52 by wheel speed sensor 72. If the vehicle is stationary, which is additionally verified by the control unit 50 by comparing the speed signals from the first and second wheel speed sensors 56 and 72, then step 112 puts the parking brake 12 into the engaged position. Otherwise, the method returns directly to step 102.

A similar procedure when locking the parking brake 12 can also be provided for the case in which the drive-position selector lever 44 has a “Power Zero” position, allowing the motor vehicle to taxi to a standstill, in addition to the neutral position. In this case, the parking brake 12 is put into the engaged position from the disengaged position after the standstill has been reached and after a prescribed safety time has subsequently elapsed.

Sometimes, release of the parking brake 12 in the manner described above is not possible, for example on account of a fault in the first operator control arrangement 40, particularly in the position sensors 46 and 48 which the latter comprises, or in the first control unit 50 and/or in the first electrical actuator 36. In this case, the method described below with respect to FIG. 4 allows emergency release of the parking brake 12.

In order to preclude unintentional emergency release, the method executed periodically by the second control unit 60 is started exclusively when the parking brake 12 is in a manually selectable emergency release mode. The emergency release mode is selected on the bypass switch 66 by plugging on the contact bridge 70 in a position provided specifically for that purpose.

When the emergency release mode has been selected on the bypass switch 66, the second control unit 60 evaluates the operation signal from the operation sensor 64 or the position signal from the third position sensor 58 in order to check, in a step 202 which follows an initialization step 200, whether the operator control pedal 62 is in the unoperated state or the drive-position selector lever 44 is in the park position. If both are the case, then step 204 evaluates the operation signal from operation sensor 64 in order to check whether the driver is deflecting the operator control pedal 62 within a prescribed dead time while the drive-position selector lever 44 remains in the park position. Otherwise, the method returns to step 202.

If the control unit 60 recognizes the presence of the operator control sequence for the operator control pedal 62 or for the drive-position selector lever 44—which operator control sequence was checked in the second step 204—then step 206 evaluates the position signal from position sensor 58 to ascertain whether the drive-position selector lever 44 is being moved from the park position into the neutral position within a prescribed dead time. Should this be the case, the second control unit 60 infers the presence of an emergency release request and step 208 puts the parking brake 12 into the disengaged position by means of appropriate actuation of the second electrical actuator 38. Otherwise, the second electrical actuator 38 is not actuated and the method returns to the step 202.

In other words, the second control unit 60 infers the presence of an emergency release request if the evaluation of a position signal provided by the third position sensor 58 in conjunction with an operation signal provided by the operation sensor 64 reveals that the drive-position selector lever 44 is being moved from the park position into the neutral position at the same time as the operator control pedal 62 is being deflected by the driver. In this respect, the second operator control arrangement 42 needs to be operated in compliance with a prescribed operator sequence within the context of a “release code” which is to be input. This reliably prevents unintentional or inadvertent emergency release of the parking brake 12 by the driver.

In summary, the parking brake control system thus has a first operator control arrangement and a control unit, wherein the control unit puts the parking brake into a disengaged position by actuating a first electrical actuator when it recognizes a release request on the first operator control arrangement. In order to be able to release the parking brake at least in the event of a fault in the first operator control arrangement and/or in the first electrical actuator, provision is also made for the control unit to put the parking brake into the disengaged position by actuating a second electrical actuator, which is independent of the first electrical actuator, redundantly when it recognizes an emergency release request on a second operator control arrangement.

The conversion of the above flow charts into a standard language for implementing the algorithm described by the flow chart in a digital computer or microprocessor, will be evident to one with ordinary skill in the art.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A parking brake control system for a motor vehicle, having a first operator control arrangement and a control unit, wherein the control unit puts the parking brake into a disengaged position by actuating a first electrical actuator in response to a release request from the first operator control arrangement, characterized by:
the control unit puts the parking brake into the disengaged position redundantly by actuating a second electrical actuator, which is independent of the first electrical actuator, in response to an emergency release request from a second operator control arrangement.

2. The parking brake control system of claim 1, wherein:
the motor vehicle is provided with an externally accessible auxiliary power connection for supplying power to the control unit together with the second operator control arrangement and the second electrical actuator.

3. The parking brake control system of claim 1, wherein:
the first operator control arrangement comprises a drive-position selector lever which can be put into at least neutral, park or drive positions and which interacts with a vehicle transmission; and
a position sensor senses a position of the drive-position selector lever.

4. The parking brake control system of claim 3, wherein:
the control unit infers existence of a release request when a position signal provided by the position sensor reveals that the drive-position selector lever is being moved from the park position to the neutral position.

5. The parking brake control system of claim 3, wherein:
the first operator control arrangement has a first position sensor which senses the park position of the drive-position selector lever, and a second position sensor which senses the neutral position of the drive-position selector lever; and
the control unit compares the position signals from the first and second position sensors with one another to verify a position of the drive-position selector lever.

6. The parking brake control system of claim 1, wherein:
the control unit infers existence of an emergency release request when the second operator control arrangement is operated in compliance with a prescribed operator control sequence.

7. The parking brake control system of claim 1, wherein:
the second operator control arrangement comprises an operator control pedal; and
an operation sensor senses an operation state of the operator control pedal.

8. The parking brake control system of claim 5, wherein:
the second operator control arrangement has a third position sensor indicating the park and/or neutral position of the drive-position selector lever;
the control unit inferring an emergency release request when a position signal from the third position sensor, in conjunction with an operation signal from the operation sensor, reveals that the drive-position selector lever is being moved from the park position into the neutral position at the same time as the operator control pedal is being operated by the driver.

9. The parking brake control system of claim 1, wherein:
the control unit puts the parking brake into the disengaged position exclusively when it is in a manually selectable emergency release mode.

10. The parking brake control system of claim 5, wherein:
the position signals from the first and second position sensors are transmitted redundantly via a bus to the control unit.

11. The parking brake control system of claim 5, wherein:
each of the first and second operator control arrangements has a separate independent control unit associated therewith for the purpose of redundantly actuating the first and second electrical actuator.

12. The parking brake control system of claim 11, wherein:
the control units communicate with each other via a CAN data bus.

13. The parking brake control system of claim 12, wherein:
the operator control arrangements, the control units and the electrical actuator are powered by at least two mutually independent power supply paths.

14. The parking brake control system of claim 1, wherein:
a wheel speed sensor senses a speed of the motor vehicle; and
the control unit puts the parking brake into the engaged position from the disengaged position exclusively when a speed signal provided by the wheel speed sensor reveals that the motor vehicle is stationary.

15. The parking brake control system of claim 1, further comprising:
a plurality of wheel speed sensors; and
the control unit comparing speed signals generated by the wheel speed sensors with one another for reciprocal verification purposes.
